(19) United States
(12) Patent Application Publication
(10) Pub. No.: US 2010/0252127 A1
(43) Pub. Date: Oct. 7, 2010

(54) DRIPPER

(76) Inventor: Itai Gross, Mizrach Binyamin (IL)

Correspondence Address: ROBERT G. LEV, 4766 MICHIGAN BLVD., YOUNGSTOWN, OH, 44505, US

(21) Appl. No.: 12/734,681

(22) PCT Filed: Nov. 12, 2008
(86) PCT No.: PCT/IL2008/001483

§ 371 Date: May 14, 2010

(30) Foreign Application Priority Data
Nov. 14, 2007 (IL) 187355

(51) Int. Cl. A01G 25/02

(52) U.S. Cl. 137/542; 137/551; 137/562

(57) ABSTRACT

A dripper unit comprising a base section and a perforated cap attached thereto; the base section for attaching to an irrigation pipe through which water flows, and having a conduit of a first diameter therein, such that some of the water flowing through the pipe flows into the conduit within the base section; the cap for regulating water flow out from the dripper unit, wherein the cap is characterized by having a plurality of apertures there through, each aperture having a different throughput, such that rotation of the perforated cap with respect to the base section brings a selected aperture from said plurality of apertures into alignment with the conduit, thereby regulating flow out of the dripper unit.

### FIELD OF THE INVENTION

The present invention relates to dripper irrigation for use in agriculture, gardens, parks, hot houses, tree nurseries, garden centers and the like.

### BACKGROUND

Plants need water and sunlight to grow. Essentially, plants use sunlight to convert carbon dioxide from the atmosphere and water into simple sugars by photosynthesis, in accordance with the following reaction:

6H₂O+6CO₂→C₆H₁₂O₆.

From this simple sugar, more complex molecules are constructed.

In arid climates, where rain cannot be relied upon, irrigation is required. Sprinkler systems are inefficient as much of the water evaporates off leaves and the ground and does not get absorbed by the roots. Furthermore, sprinklers tend to cause shallow rooting, whereas, it is generally preferable for plants to grow deep roots.

It has long been appreciated that drip irrigation is the most ecologically friendly type of irrigation in that water can be supplied in near optimal amounts, exactly where needed. The depth of penetration is dependent on soil type, humidity and plant cover. Nevertheless, in general, drippers tend to result in wetting in a deep, conical pattern around the dripper, which aids the growth of strong roots.

Preferably, drippers are situated a few centimeters from seedlings, to challenge the roots, causing them to grow towards the moisture; it also being appreciated that too much moisture can cause roots to rot.

Dripper systems comprise conduits with multiple drippers there along, each dripper being dedicated to an individual plant, or when used for watering lawns or ground covering plants, for small, well defined areas.

The amount of water required by a field is dependent on the season, the temperature and humidity. Some plants need more water as they grow. Grains need more irrigation at germination and early plant growth, and less as the plants ripen.

To some extent, the amount of water provided by a dripper system can be controlled, by running the dripper system more frequently or for longer watering periods. However, any system, or at least, any branch pipe thereof, is considered as a unit, and all drippers there-along are switched on and off together. This is adequate where all plants along a conduit pipe have identical requirements to each other, in which case all drippers are identical. This is also acceptable where the requirements of separate plants along the conduit are in a simple ratio, in which case different drippers may be selected with different throughputs may be selected, or the separation of different drippers may vary along the conduit.

Typically individual drippers are rated as providing ½, 1, 2, 4, or 8 liters an hour. It will generally be appreciated that these numbers are only approximate, and the throughput of individual drippers with the same nominal rating may vary considerably. Furthermore, the actual throughput of a dripper will depend on the water pressure applied thereto.

Frequently such variations hardly matter, since the farmer or gardener switches the irrigation system on for longer or shorter periods, depending on how the plants look. Agriculture has never been certain, and irrigation systems are more predictable than rain.

Generally, on a micro-scale, fields and gardens are not homogenous in terms of local soil makeup and drainage. The presence of nearby buildings and trees can affect the amount of irrigation that plants need. In gardens and plant nurseries especially, there are often different plants drawing water from drippers on the same conduit. Furthermore, where the same plant is planted in a row along a border or flower bed, the plants may grow faster and thus larger towards one side of the flower bed, which may be unsightly. Indeed research using infrared inspection carried out by the Volcani Institute, Israel, has found that even in fields with homogeneous crops, such as potato crops, there are differences in water absorption by different individual plants.

Whereas it is relatively easy to control the amount of water supplied via a conduit as a whole, it is not generally possible to vary the output of individual drippers along a common conduit. In some applications this would be desirable.

U.S. Pat. No. 3,876,155 titled “Drip-type irrigation emitter” describes a drip-type irrigation emitter having interchangeable orifice discs to perform flush, drip and mister functions. Essentially, a basic emitter unit is designed for automatic self-flushing and drip operation, but which can be readily modified by adding parts to convert it to a combination drip irrigation emitter and mister for spraying finely divided particles of heated water into the air to warm the air to prevent frost damage to plants, trees, etc. By the substitution of differently designed orifice discs, the basic emitter unit can be made self-flushing and to provide misting only, or to be self-flushing and function as an unlimited-pressure mister. By alternative minor disc modification, the basic emitter unit can be connected at the end of an irrigation line to effect flushing of the line only.

The basic emitter unit is further characterized by its capability of (1) automatically compensating for variations in line pressure and changes in elevation of terrain; (2) maintaining a uniform flow rate regardless of variations in line pressure; (3) eliminating the necessity of water filtration; (4) when connected with other emitters in an irrigation line, taking advantage of line friction and enabling flushing and seating of the emitters progressively under very low line pressure; and (5) eliminating the need for a dual pump system.

The above dripper is designed to deliver a desired quantity of water in a preset manner that may be set to a particular function, by being opened and the disks therein being interchanged. Once set to provide output of a desired type, such as a mist or a drip of certain throughput, and installed in a system, the drip outputs are not easily varied, in that each dripper has to be opened and the orifice disk therein interchanged. If soil or grit becomes adhered to the orifice disks, the dripper units become difficult to close and tend to malfunction, being susceptible to blockages. Since they are installed on the ground, this problem is almost unavoidable.

U.S. Pat. No. 4,722,481 titled “Adjustable drip emitter” relates to an adjustable irrigation drip emitter having a moulded plastics body with a housing to receive a shank on plug. Several embodiments of drip emitters are disclosed. Each embodiment comprises (1) a molded plastic, body with an upwardly opening housing, and (2) a molded plastic plug including an enlarged head, a depending shank, and a helical thread defined about the perimeter of the shank. The body is executed in a relatively soft plastic, while the plug is executed in a harder plastic. The shank of the plug is press-fitted into the housing, and the threads on the shank of the plug cut into the softer plastic of the housing. By advancing or retracting the plug, the length of the helical flow path is altered and the rate of discharge of droplets from the emitter is adapted thereby, to account for changes in line pressure, accumulation of debris in the emitter, and other operational parameters.

U.S. Pat. No. 3,873,031 titled “Weeper Irrigation System and Method” describes a self-sealing weeper irrigator having an adjustable flow rate by means of a snap-on cap. Essentially, a weeper type irrigation system and method featuring unusual flexibility of use and mode of assembly and the variety of results obtainable there from is described. The weeper proper is quickly installable in a self-sealing manner in the side of a plastic water distributing manifold or tube, and is operable to provide either a misty spray discharge into the air or weeper flow at more than one selected rate. Alternatively, the weeper flow may be directed laterally into the air or conducted to a more remote discharge point or along the exterior of the weeper. The weepers are readily installable remotely from or in close proximity to one another and each weeper is individually operable at will to dispense water in a selected manner and at a selected rate. A protective cap is installable with a snap fit over the outer end and selectively adjustable thereon to provide fast or slow weeper flow as well as to convert the discharge between a confined flow at either a slow or fast rate and into either a widely dispersed misty spray or a confined flow. A simple tool functions to punch or blank a disc from the plastic water distributing manifold into which the weeper is then installable with a self-sealing self-retaining fit with the axis of the weeper supported upwardly with a captive pressure-responsive valve free for movement between several different operating positions.

Both the above referenced patents allow the throughput of individual drippers along a conduit of a dripper irrigation system to be individually varied. The variance is controlled by rotating the plug and conventionally, anti-clockwise rotation results in increasing the throughput, whereas clockwise rotation results in decreasing the throughput. This is in accordance with standard plumbing and engineering practice. Nevertheless, it has been found that many farmers and gardeners, particularly, those that are left handed, forget this common convention. Furthermore, it is difficult, if not impossible, to ascertain the throughput through such a sprinkler, merely by inspection thereof. Particularly when water is not flowing through the system, as is typically the case, most of the time.

In some applications, it is desirable to set the water throughput in a pressure and the present invention addresses this need.

### SUMMARY OF THE INVENTION

It is an aim of the present invention to provide a dripper unit that can be installed on a water conduit and subsequently configured to set the throughput thereof by rotating one part with respect to another part, similar to opening a faucet or valve, such that the throughput therethrough can be easily visualized by the operator.

In accordance with one embodiment of the invention there is provided a dripper unit comprising a base section and a perforated cap attached thereto; the base section for attaching to an irrigation pipe through which water flows, and having a conduit of a first diameter therein, such that some of the water flowing through the pipe flows into the conduit within the base section; the cap for regulating water flow out from the dripper unit, wherein the cap is characterized by having a plurality of apertures there through, each aperture having a different throughput, such that rotation of the perforated cap with respect to the base section brings a selected aperture from said plurality of apertures into alignment with the conduit, thereby regulating flow out of the dripper unit.

Typically the first diameter exceeds the diameter of all the apertures.

Preferably, the perforated cap is annotated with throughput indicators adjacent to the apertures for indicating the typical throughput therethrough in terms of volume per unit time.

Most preferably, the cap is annotated with throughput indicators calibrated in liters per hour.

Typically the cap is attached to the base section by a central pivoting coupling, the conduit terminates in a mouth, off center to the coupling, and the apertures are arranged in a circular configuration around the central pivotal coupling such that each aperture may be selectively aligned with the mouth of the conduit.

Typically, the end of the conduit opposite the mouth terminates in a stiff truncated conical plug for engaging a hole in the irrigation pipe.

Optionally the dripper unit further comprises an anchoring means and a flexible tube of length l, that is coupled to the conduit; the anchoring means for anchoring the dripper unit to ground there under, and the flexible tube for coupling to the irrigation pipe such that the dripper unit may be positioned at a range of distances from the irrigation pipe from adjacent thereto, to separated therefrom by a distance l.

Typically, the distance l is 10 cm.

Preferably the flexible tube terminates in a stiff truncated conical plug for engaging a hole in the irrigation pipe.

In one embodiment, the anchoring means is a spike for anchoring to the ground.

In another embodiment, the anchoring means is a clasp for anchoring to the conduit.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is an isometric view of a dripper unit in accordance with one embodiment of the present invention;

FIG. 2 is an exploded view of the dripper unit of FIG. 1;

FIG. 3 is an isometric view of a dripper unit in accordance with a second embodiment of the present invention;

FIG. 4 is an exploded view of the dripper unit of FIG. 3, and

FIG. 5 is an isometric view of a dripper unit in accordance with a third embodiment of the present invention.

### DESCRIPTION OF THE PREFERRED EMBODIMENTS

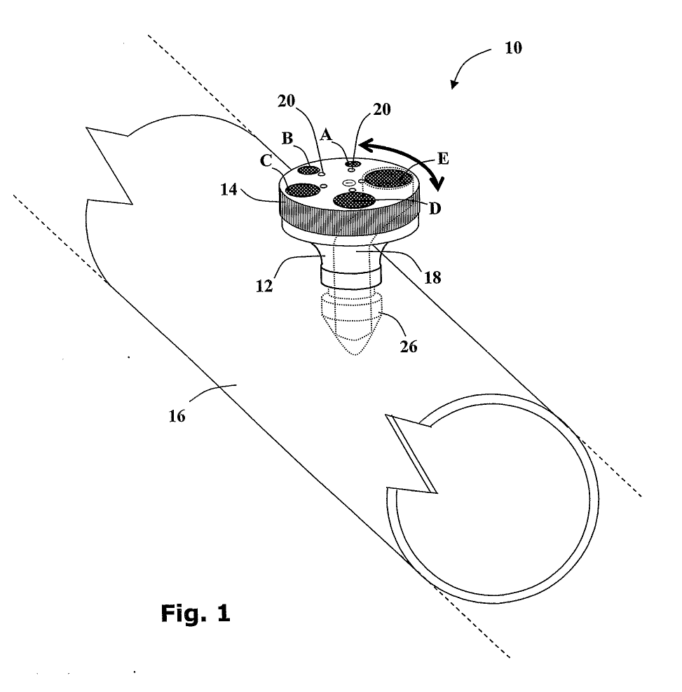

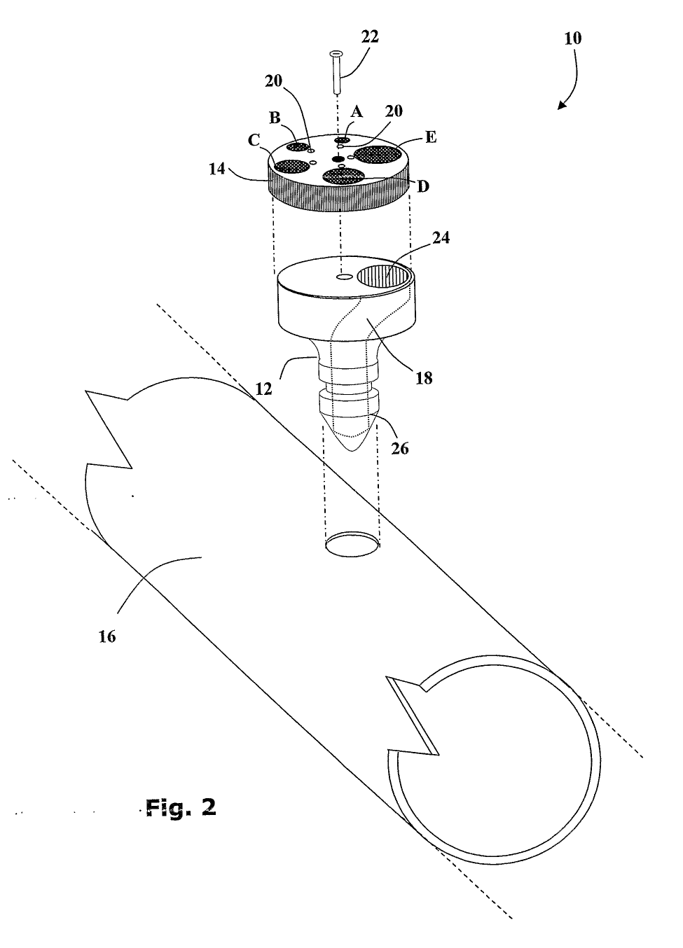

With reference to FIGS. 1 and 2, a dripper unit 10 in accordance with one embodiment of the invention is shown. The dripper unit 10 essentially comprises a base section 12 with a perforated cap 14 attached thereto. The base section 12 is attachable to an irrigation pipe 16 through which water flows. A conduit 18 of a first diameter d is fabricated in the base section, such that some of the water flowing through the irrigation pipe 16 flows into the conduit 18 within the base section 12; the cap 14 for regulating water flow out from the dripper unit 10, wherein the cap 14 is characterized by having a plurality of apertures A-E there through, each aperture having a different throughput, such that rotation of the perforated cap 14 with respect to the base section 12 brings a selected aperture A (B, C, D, E) from the plurality of apertures A-E into alignment with the conduit 18, thereby regulating flow out of the dripper unit 10.

The first diameter, i.e. the diameter of the conduit 18 exceeds the diameter of all the apertures A-E so each aperture A-E, servers as a regulator of fluid flow through the dripper unit 10, regulating the flow of water there through, by regulating the water pressure and size of drips. In preferred embodiments, the perforated cap 14 is annotated with throughput indicators 20 adjacent to the apertures A-E for indicating the typical throughput there through in terms of volume per unit time, calibrated in liters per hour, for example.

Typically the cap 14 is attached to the base section 12 by a central pivoting coupling 22 and the conduit 18 terminates in a mouth 24 that is off-center to the coupling 22 and the apertures A-E are arranged in a circular arrangement about the central pivotal coupling 22, such that each aperture A (B, C, D, E) may be selectively aligned with the mouth 24 of the conduit 18.

Typically, the end of conduit 18 opposite the mouth 24 terminates in a stiff truncated conical plug 26 for engaging a hole 28 in the irrigation pipe 16. Such truncated conical plugs 26 may be press fitted into appropriately sized holes 28 in the irrigation pipe 16, as pierced therein, by an appropriate tool, as known for commercially available, prior art drippers.

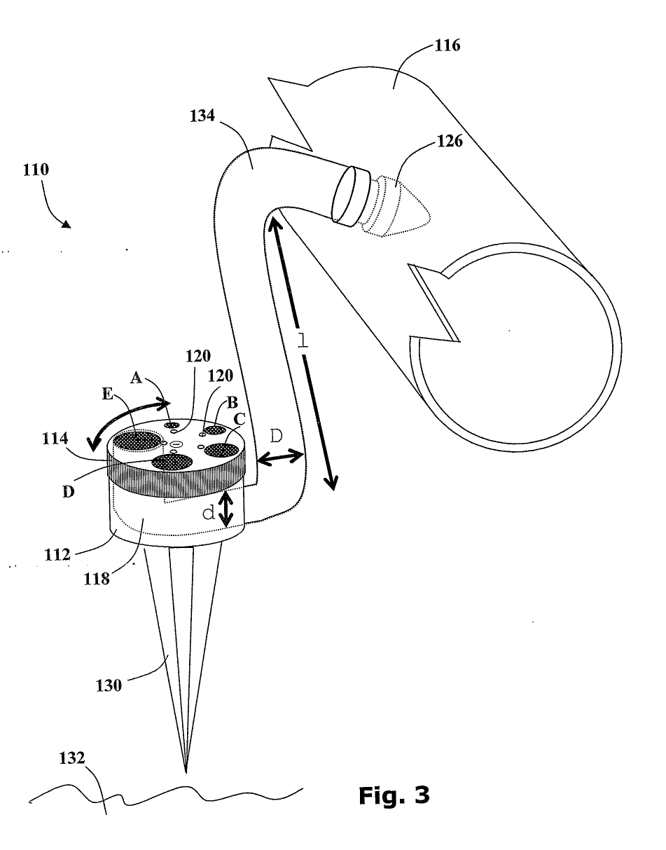

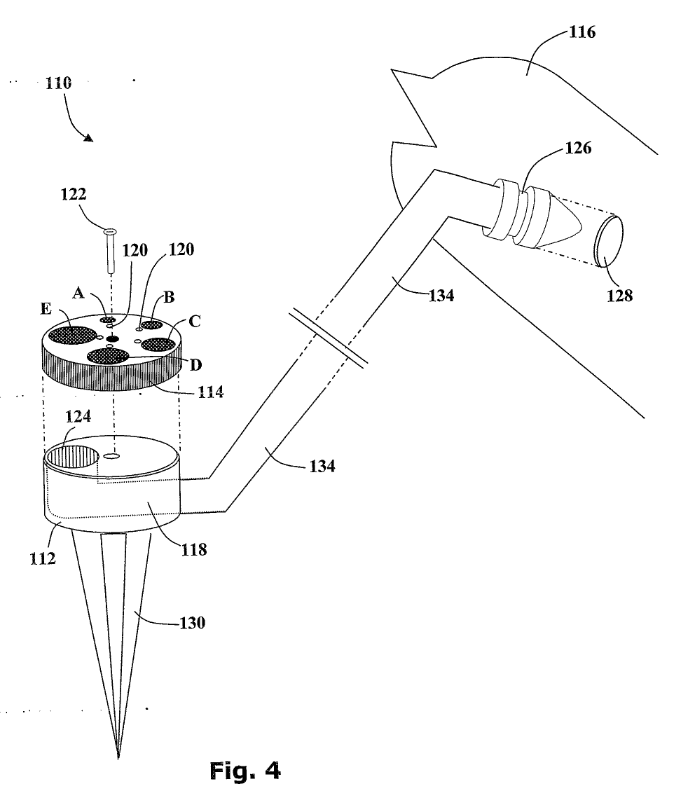

With reference to FIGS. 3 and 4 in a second embodiment, a dripper unit 110 is provided, consisting of base section 112, perforated cap 114 for attaching to an irrigation pipe 116 through which water flows. A conduit 118 of first diameter fabricated in the base section 112, the cap 114 being characterized by having a plurality of apertures A-E there through, throughput indicators 120, a central pivoting coupling 122; the conduit 118 terminates in a mouth 124 that is off center to the coupling 122, mutatis mutandis, and further includes a spike 130 for anchoring the dripper unit 110 to the ground 132 there under, and a flexible tube 134 of similar diameter D to the diameter d of the conduit 118. The flexible tube 134 has a length l; the spike 130 and the flexible tube 134 that is coupled to the conduit 118 for coupling to the irrigation pipe 116 such that the dripper unit 110 may be positioned at a range of distances from the irrigation pipe 116, from adjacent thereto, to separated therefrom by a distance l, being the length of the flexible tube 134; the distance l being in the range of 8 cm to 15 cm, and typically being about 10 cm.

The distal end of the flexible tube 134 opposite the mouth 124 thereof, terminates in a stiff truncated conical plug 126 for engaging a hole 128 in the irrigation pipe 116. Such truncated conical plugs 126 may be press fitted into appropriately sized holes 128 in the irrigation pipe 116, as pierced therein, by an appropriate tool, as known for commercially available, prior art drippers.

The dripper unit 110 not only allows the throughput thereof to be individually tailored to specific requirements of individual plants, but also allow may be moved over a distance of 21, that is a distance of l either side of the anchor hole 128 where it is attached to the irrigation pipe 116. In this manner, the dripper unit 110 may be repositioned as the plant grows, to challenge it, and to cause root hairs to extend outwards there from.

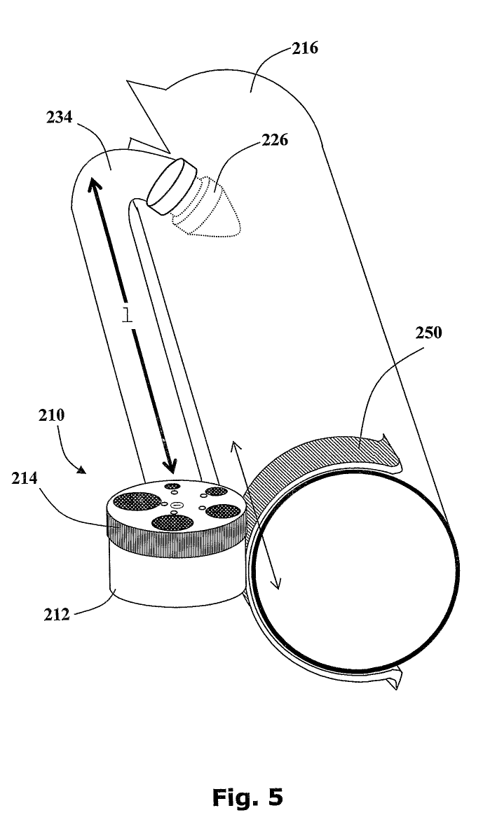

Referring now to FIG. 5, in a third embodiment of the current invention, a dripper unit 210 is provided. Dripper unit 210 consists of a base section 212, a perforated cap 214 for attaching to an irrigation pipe 216 through which water flows and a flexible tube 234 of length l, coupled to the dripper unit. The distal end of the flexible tube 234 terminates in a stiff truncated conical plug 226 for engaging a hole in the irrigation pipe 216. A clasp 250, such as a C-ring, for example, is additionally provided for slidably coupling the dripper unit 210 to the irrigation pipe 216. The dripper unit 210 of the third embodiment may thus be positioned along the irrigation pipe 216 at any distance l, on either side of the anchor hole.

The present invention is capable of some variation and the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A dripper unit comprising a base section and a perforated cap attached thereto; the base section for attaching to an irrigation pipe through which water flows, and having a conduit of a first diameter therein, such that some of the water flowing through the pipe flows into the conduit within the base section; the cap for regulating water flow out from the dripper unit, wherein the cap is characterized by having a plurality of apertures there through, each aperture having a different throughput, such that rotation of the perforated cap with respect to the base section brings a selected aperture from said plurality of apertures into alignment with the conduit, thereby regulating flow out of the dripper unit.

2. The dripper unit of claim 1, wherein the first diameter exceeds the diameter of all the apertures through the perforated cap.

3. The dripper unit of claim 1, wherein the perforated cap is annotated with throughput indicators adjacent to the apertures for indicating the typical throughput therethrough in terms of volume per unit time.

4. The dripper unit of claim 3, wherein the cap is annotated with throughput indicators calibrated in liters per hour.

5. The dripper unit of claim 1, wherein the cap is attached to the base section by a central pivoting coupling, the conduit terminates in a mouth that is off center to the coupling, and the apertures are arranged in a circular configuration around the central pivotal coupling such that each aperture may be selectively aligned with the mouth of the conduit.

6. The dripper unit of claim 6, wherein end of conduit opposite the mouth terminates in a stiff truncated conical plug for engaging a hole in the irrigation pipe.

7. The dripper unit of claim 1, further comprising an anchoring means and a flexible tube of similar diameter to the diameter of the conduit of a length l, that is coupled to the conduit; the anchoring means for anchoring the dripper unit and the flexible tube for coupling to the irrigation pipe such that the dripper unit may be positioned at a range of distances from the conduit from adjacent thereto, to separated there from by a distance l.

8. The dripper unit of claim 7, the anchor being a spike for anchoring to the ground therebeneath.

9. The dripper unit of claim 7, the anchor being a clasp for anchoring to the irrigation pipe.

10. The dripper unit of claim 9, the anchor being a C-ring for anchoring to the irrigation pipe.

11. The dripper unit of claim 7, wherein the distance 1 is in the range of from 8 cm to 15 cm.

12. The dripper unit of claim 7, wherein the distance 1 is about 10 cm.

13. The dripper unit of claim 7 wherein the flexible tube terminates in a stiff truncated conical plug for engaging a hole in the irrigation pipe.
